(19) United States
(12) Patent Application Publication
(10) Pub. No.: US 2010/0127809 A1
(43) Pub. Date: May 27, 2010

(54) Direct printable rubber magnet

(75) Inventors: Xiaoming Wang, Guangdong Province (CN); Guoming Wu, Guangdong Province (CN); Longzhang Wu, Guangdong Province (CN)

Correspondence Address: YH CHAN, 42 PIN OAKS DRIVE, PHOENIXVILLE, PA, 19460, US

(73) Assignee: Guangzhou Newlife Magnet Electricity Co., Ltd., Guangdong Province (CN)

(21) Appl. No.: 12/593,919

(22) PCT Filed: Feb. 13, 2008
(86) PCT No.: PCT/CN08/00343

§ 371 Date: Sep. 30, 2009

(30) Foreign Application Priority Data
Jul. 31, 2007 (CN) 200720054949.5

(51) Int. Cl. H01F 7/02; B05D 5/12

(52) U.S. Cl. 335/302; 427/127

(57) ABSTRACT

This utility model is a kind of direct printable rubber magnet, including bonded magnet. The said bonded magnet is applied with coating on surface. The said coating is cemented to the said bonded magnet surface. With coating on surface, this rubber magnet can be directly printed, written and/or beautified on the surface, achieving same effect which current rubber magnets must achieve after laminating with plastic or paper. This makes its structure more simple and can be accomplished by common coating method, so it is reasonable-crafted, simple-operated, easy-applied and cost-saving. This rubber magnet is also easy to be recycled. As this product has no plastic or paper which is difficult to be recycled, and the coating holds a tiny percentage and can be recycled together with the bonded magnets without any other separating process, it is easy to be recycled with low cost, so it is good for environment protection.

### BACKGROUND OF THE INVENTION

This utility model relates to rubber magnet, especially to a kind of direct printable rubber magnet.

Traditional rubber magnets having a printable function commonly consist of bonded magnet layer and an outer layer. The bonded magnet layer can be bonded with magnetic power or ferrous power. The outer layer is usually plastic (eg. PVC) or paper (eg. gloss paper). The outer layer is laminated onto the bonded magnet layer, and then the surface of the outer layer can be printed, written or decorated with different images in order to decorate the rubber magnet.

Such traditional rubber magnets can be in variety of forms and are able to stick onto ferrous or magnetic surfaces for decoration. Whereas, this kind of rubber magnet has obvious shortcomings:

(1) As for production process, since it must be laminated with plastic or paper layer, manufacturer must specially setup a lamination process, which makes the process more complicated. And the price of plastic and paper material is relatively high. So both raw material and process cost of this kind of rubber magnet is correspondingly high.

(2) It is quite complex to recycle this kind of rubber magnet when it is not to be used. Because the plastic or paper material is different from bonded magnet material, we must separate the outer layer from the bonded magnet layer before recycling. But the cost is relatively high to separate them because they have been combined firmly, so this kind of rubber magnet is not propitious to recycle.

### BRIEF SUMMARY OF THE INVENTION

The purpose of this utility model is to overcome the shortcomings of the above traditional rubber magnet, and supplies a kind of direct printable rubber magnet which is in simple structure, easy to process and recycle.

This utility model has such unique techniques to achieve above purpose as follows: A kind of direct printable rubber magnet, including bonded magnet, is characterized by: the said bonded magnet is applied with coating on surface. The said coating is cemented to the said bonded magnet surface.

The said coating can be applied on only one surface or both surfaces of the bonded magnet. If the bonded magnet is quite thick, the coating can also be applied along the thickness.

The said coating can be only one layer or even several layers.

Raw material of the said coating can be water-based or oil-based printing paint or inkjet printing paint.

The said bonded magnets are in sheet form which can be bonded with hard or soft magnet material made of metal, metallic oxide or alloy and binder. The said bonded magnets are usually planar sheets (such as square sheet, strip, or band) with good flexibility and can be twisted into arch, ring or roll shape.

The said coating can be transparent, sole color, multicolor or polychrome.

The said coating is quite thin, with dry-up film usually weighs from 5˜200 g/m².

Comparing with traditional technics, this utility model provides a number of advantages and effects as following:

(1) With coating on surface, this rubber magnet can be directly printed, written and/or beautified on this coating(because the coating layer is very thin, it works almost same as operating directly on the bonded magnet), achieving same effect which current rubber magnets must achieve after laminating with plastic or paper. This makes its structure more simple and can be accomplished by common coating method, so it is reasonable-crafted, simple-operated, easy-applied and cost-saving.

(2) This rubber magnet is also easy to be recycled. As this product has no plastic or paper which is difficult to be recycled, and the coating holds a tiny percentage and can be recycled together with the bonded magnets without any other separating process, it is easy to be recycled with low cost and environmental.

### BRIEF DESCRIPTION OF THE DRAWINGS

FIG. 1 is a schematic diagram for one kind of structure of this utility model.

FIG. 2 is a schematic diagram for another kind of structure of this utility model.

FIG. 3 is a schematic diagram for a third kind of structure of this utility model.

FIG. 4 is a schematic diagram for a fourth kind of structure of this utility model.

### DETAILED DESCRIPTION OF THE INVENTION

Following are detailed descriptions of this utility model with some examples of processing and attached drawings, but actual process of this utility model is far more than the four examples.

One concrete structure of this utility model is illustrated in FIG. 1. As illustrated in FIG. 1, the rubber magnet has bonded magnet 1, and the surface of bonded magnet 1 is applied with sole color coating 2. The bonded magnet 1 is cemented with sole color coating 2. The bonded magnet 1 is schistose made of magnetic powder with such binders as CPE, PVC, EVA, PE, nylon, NBR and/or PP. The sole color coating 2 can be water-based or oil-based printing paint, and can be directly coated to the surface of the bonded magnet 1. The sole color coating 2 is quite thin, with dry-up film usually weighs from 5˜200 g/m².

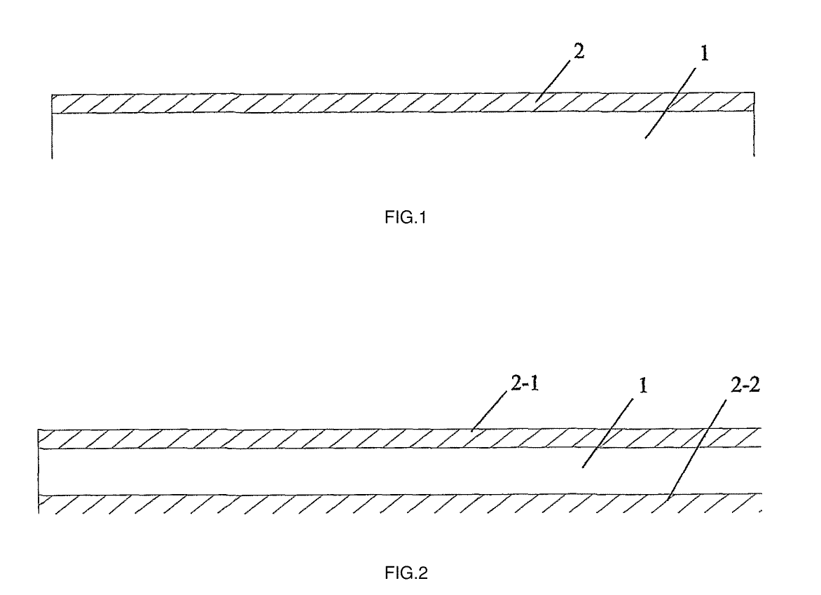

Another concrete structure of this utility model is illustrated in FIG. 2. As illustrated in FIG. 2, this rubber magnet is same as FIG. 1 except that: the bonded magnet 1 has coating on both upper and under surfaces. The coating 2-1 on upper surface is sole color, whose material can be water-based or oil-based inkjet printing paint; the coating 2-2 on under surface is transparent, whose material can be water-based or oil-based printing paint. The bonded magnet 1 is schistose made of magnetic powder with such binders as CPE, PVC, EVA, PE, nylon, NBR and/or PP.

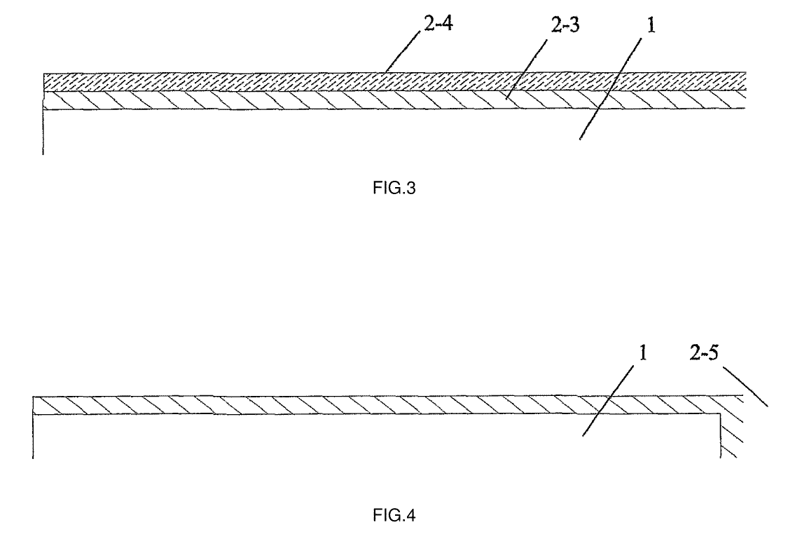

A third concrete structure of this utility model is illustrated in FIG. 3. As illustrated in FIG. 3, this rubber magnet is same as FIG. 1 except that: the bonded magnet 1 has two coating layers 2-3 and 2-4 on upper surface. The coating 2-3 is monochrome, whose material can be water-based or oil-based printing paint, and the coating 2-4 is polychrome, whose material can be water-based or oil-based inkjet printing paint.

A fourth concrete structure of this utility model is illustrated in FIG. 4. As illustrated in FIG. 4, this rubber magnet is same as FIG. 1 except that: another coating layer 2-5 is applied along thickness since the bonded magnet 1 is quite thick. The coating 2-5 is applied on the right side of bonded magnet along thickness.

The above 4 kinds of methods of implementation are currently best methods of this invention, but this invention is not limited within only the above 4 methods. Any changes, modifications, alternatives, combinations or simplifications under the spirit and principle of this invention should be involved and protected in this invention.

We claim:

1. A kind of direct printable rubber magnet, including bonded magnet, is characterized by: the said bonded magnet is applied with coating on surface. The said coating is cemented to the said bonded magnet surface.

2. The direct printable rubber magnet referred in claim 1 is characterized by: the said coating can be applied on only one surface or both surfaces of the bonded magnet.

3. The direct printable rubber magnet referred in claim 1 is characterized by: the said coating can also be applied along the thickness of the bonded magnet.

4. The direct printable rubber magnet referred in claim 1 is characterized by: the said coating can be only one layer or even several layers.

5. The direct printable rubber magnet referred in claim 1 is characterized by: the said bonded magnet is in sheet form which can be bonded with hard or soft magnet material made of metal, metallic oxide or alloy and binder.

6. The direct printable rubber magnet referred in claim 1 is characterized by: the said bonded magnet is flat sheet.

7. The direct printable rubber magnet referred in claim 1 is characterized by: the said coating can be transparent, sole color, multicolor or polychrome.

8. The direct printable rubber magnet referred in claim 1 is characterized by: the dry-up film of the said coating can weigh from 5˜200 g/m².
